(19) United States
(12) Patent Application Publication
(10) Pub. No.: US 2016/0188121 A1
(43) Pub. Date: Jun. 30, 2016

(54) Ultra-Wide-Angle Touch Detection for Interactive Projection

(71) Applicant: Texas Instruments Incorporated, Dallas, TX (US)

(72) Inventor: Alexander Lyubarsky, Dallas, TX (US)

(21) Appl. No.: 14/587,759

(22) Filed: Dec. 31, 2014

(51) Int. Cl. G06F 3/042

(52) U.S. Cl. CPC G06F 3/0425

(57) ABSTRACT

Interactive projection apparatus, with apparatus for projecting an image toward a screen and apparatus for capturing a reflection from an object touching a point adjacent the screen. The capturing apparatus includes: (1) a curved mirror for receiving light representing the reflection; (2) at least one lens to which the curved mirror reflects light representing the reflection; and (3) a camera for receiving light representing the reflection from the at least one lens.

### CROSS-REFERENCES TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

The preferred embodiments relate to interactive projectors.

Interactive projectors project an image and also provide the user ability to interact with that projected image by the projector detecting, for example, touching, writing, and the like on the projected image. This allows the user to select, manipulate, and modify the projected image, and the detecting/projecting apparatus must be highly accurate in detecting and tracking the user's input. Such interaction requires a camera that can precisely detect a light source and through software algorithms, interaction can be achieved by adjusting the projected image to correspond to the user input.

As projectors become more prolific and technology advances, so-called wide and ultra-wide projection angles have become more popular. These systems locate the projector closer to the screen so as to have a much smaller yet wider projection angle, as may be desirable, for example, to reduce casting shadows that could appear when a user stands in front of and close to the screen. The distance from the projector's lens to the screen is referred to as the “throw distance,” and when divided by the screen width provides a “throw ratio.” By moving the projector closer to the screen, therefore, throw distance reduces and, hence, so does throw ratio. Short throw projectors have a throw ratio generally between 0.38 and 0.7, while ultra-short throw is typically below 0.38. Such ultra-short throw projectors must cast an image over a considerably wide angle. Similarly, for an interactive ultra-short throw projector, its camera must detect the image and image interaction with the same constraints. As a result, ultra-wide angle cameras are particularly needed for short throw and ultra-short throw projectors to provide interactivity functions. These camera lenses must address parameters, like ultra-short throw projectors, in the sense that a large image (˜100″ diagonal) is produced/captured at a very short distance (˜0.18 throw ratio), with a goal of little or no distortion. Further, interactive detection accuracy for such interactive projectors is greatly affected by the optical distortion of the camera lens, which for short throw or ultra-short throw devices typically requires complex and expensive lens designs. These requirements avoid so-called fisheye or barrel distortion and produce a low distortion rectilinear image.

Given the preceding, the present inventor has identified potential improvements to the prior art, as are further detailed below.

### BRIEF SUMMARY OF THE INVENTION

A preferred embodiment provides an interactive projection apparatus, comprising apparatus for projecting an image toward a screen and apparatus for capturing a reflection from an object touching a point adjacent the screen. The capturing apparatus comprises: (1) a curved mirror for receiving light representing the reflection; (2) at least one lens to which the curved mirror reflects light representing the reflection; and (3) a camera for receiving light representing the reflection from the at least one lens.

Numerous other inventive aspects and preferred embodiments are also disclosed and claimed.

### BRIEF DESCRIPTION OF THE SEVERAL VIEWS OF THE DRAWING

FIG. 1a illustrates a frontal diagrammatic view of an interactive projector/camera relative to a screen.

FIG. 1b illustrates a side view of the system of FIG. 1a projecting from the projector to the screen.

FIG. 1c illustrates a side view of the system of FIG. 1a reflecting from an infrared (IR) curtain to a detection apparatus.

FIG. 2 illustrates a plot for demonstrating the rectilinear rendering from the known barrel effect.

FIG. 3 illustrates a preferred embodiment detection apparatus including a lens, mirror, and circuit configuration for detecting reflections from the system screen.

FIG. 4 illustrates a plot of the rectilinear rendering achieved by the preferred embodiment lens and mirror configuration of FIG. 3.

### DETAILED DESCRIPTION OF EMBODIMENTS

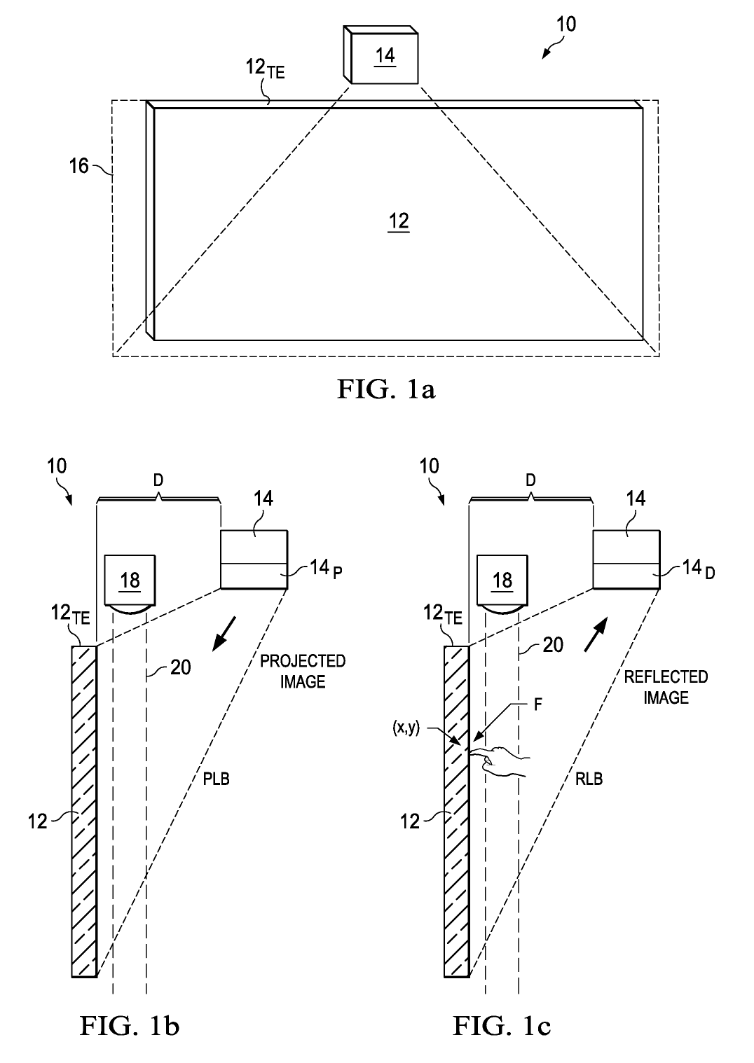

FIG. 1a illustrates a frontal system diagrammatic view of an interactive projector system 10, and FIGS. 1b and 1c illustrate side views of system 10. In general, system 10 may include various attributes known in the art, but according to a preferred embodiment its interactivity is further improved as detailed below. By way of introduction, however, known aspects of system 10 are first described, followed later by additional details with respect to the preferred embodiment improvements.

System 10 includes a screen 12 that may have various dimensions and is typically attributed a size by measuring across its diagonal. For example, in contemporary systems, screen 10 may be 8 feet or larger across its diagonal. Note that different screen ratios are known in the art, such as either 4:3 or 16:9, in which case the diagonal still may be in the range stated, but the field of view will differ. Screen 12 may be any material or surface suitable for receiving and displaying a projected image at an acceptable level based on user expectation, price, and the like.

System 10 also includes a projector 14, positioned relative to screen 12 so as to project a wide angle across screen 12. Typically, for example, projector 14 is mounted at a height that is above the top edge 12_{TE} of screen 12, and as shown in FIGS. 1b and 1c at a lateral distance D, which for a 100 inch diagonal screen may be in the range of 15 to 34 inches for a 16:9 aspect ratio and throw ratio of 0.18 to 0.38, and may be in the range of 14 to 31 inches for a 4:3 aspect ratio for the same throw ratio of 0.18 to 0.38. Such dimensions, therefore, provide for an ultra-short throw ratio. As shown in FIGS. 1a and 1b, projector 14 thereby projects an image to screen 12.

Projector 14 has some type of housing or other support and enclosure, as shown in FIG. 1b, for apparatus 14_{P} for processing and projecting an image, and preferably further supporting detection apparatus 14_{D} for detecting and processing any interactive reflections. Such apparatus are not expressly shown in separate detail as they are understood in the art. By way of overview, projecting apparatus typically includes an image source and a a light source. The image source may be a digital micromirror device (DMD) array, as is commercially available as part of DLP® technology from Texas Instruments Incorporated. The DMD array includes over a million tiny, highly reflective micromirrors forming a micro-electrical-mechanical system, whereby each mirror may be individually tilted to selectively reflect light, as a pixel, from a light source. In alternative preferred embodiments, other image sources may be implemented, including for example liquid crystal display (LCD) technology. The light source, used in conjunction with the image source, may include one or more light sources, such as red/green/blue (RGB), that may combine to form myriad colors. Together with the image source, the result is an image projection light beam PLB. A processing circuit including hardware and/or software, and as known in the art for light and image control and processing, which may therefore include a digital signal or other processor, memory, and related apparatus, is also included and associated with these projecting apparatus. The processing circuit thus receives or stores image data that is converted to the appropriate control signals for the mirrors (or other modulator) of the image source, and illumination is provided by a light source(s) so that the projected light matches the pattern/color of the desired image data and produces projection light beam PLB. Typically one or more lenses, arranged either in a barrel or other alignment, also may be included in the path of the projected beam.

Projector 14 further includes, as shown generally in FIG. 1c, detection apparatus 14_{D} for detecting and processing interactive reflections from screen 12, where by way of example FIG. 1c indicates a reflected light beam RLB and detection apparatus 14_{D} are further detailed later. By way of introduction, detection apparatus 14_{D} is operable to detect when an object, such as a finger F as illustrated at point (x, y) in FIG. 1c, touches a coordinate position relative to plane defined by the front of screen 12. Indeed, detector 14_{D} typically is operable to detect an area slightly larger than screen 12, shown as a perimeter area 16 in FIG. 1a (e.g., and exceeding screen 12 by some number of pixels, such as 30, pixels). In a preferred embodiment, detection apparatus 14_{D} detects a scattering or reflection of infrared (IR) or near-infrared (near-IR) light that is nearby or a part of screen 12. Near-IR light for purposes of demonstration may be in the wavelength range of 750 to 1100 nm. Toward this end, FIGS. 1b and 1c illustrates an IR/near-IR illumination source 18 adjacent the outside/viewer side of screen 12, which for the preferred embodiment emits a near-IR light in the range of 850 to 950 nm, where for a particular preferred embodiment the emitted light has a wavelength of 910 nm. Illumination source 18 includes a light source (e.g., laser) and a typically-cylindrical lens through which the emitted light passes that thereby projects the light in a curtain 20 (or “fan”) across a majority or all of an area adjacent (e.g., within 5 mm of) the viewer's side of screen 12. An interactive touch (e.g., by finger F) thus interrupts light curtain 20, thereby causing scattering and reflections, and detection apparatus 14_{D} attempts to detect such a reflection and its position (x, y) relative to the area of screen 12.

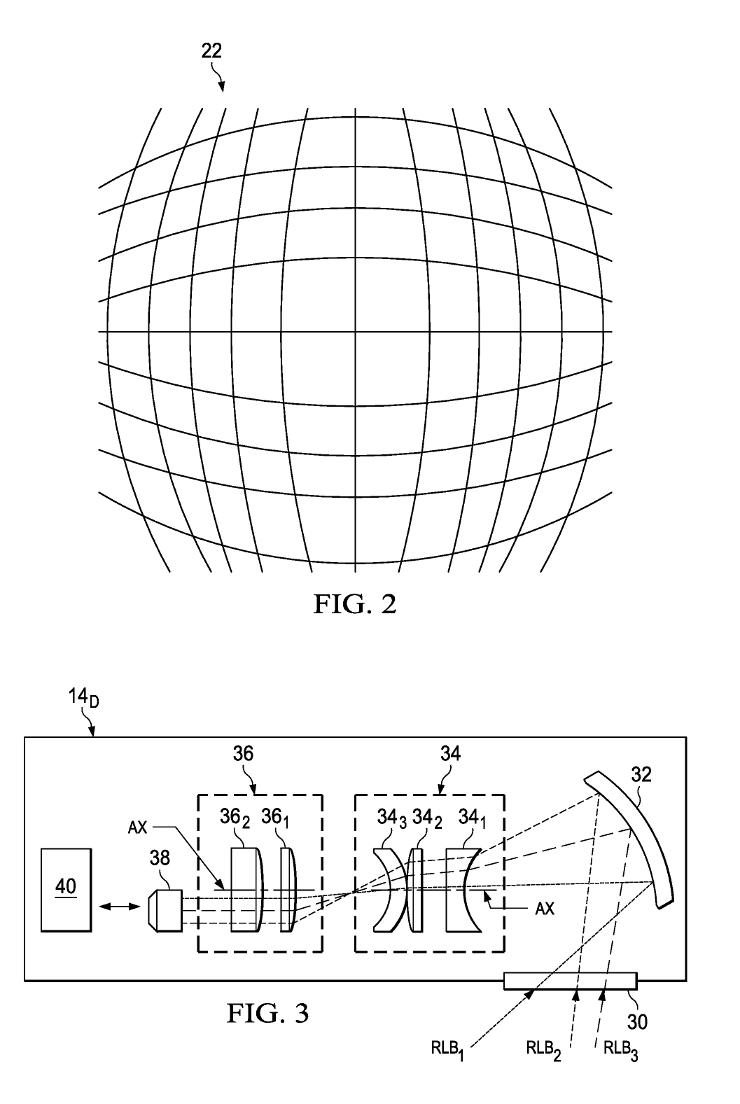

In the preferred embodiments wherein interactive projector system 10 is included in an ultra-short throw configuration, an issue may arise in connection with reflected images and accurate detection of position (x, y), as is now discussed in connection with the illustration of FIG. 2. Specifically, the ultra-short throw configuration creates a wide-angle perspective from detection apparatus 14_{D} relative to screen 12. As a result, with unsophisticated lens and cameras, and the like to process the reflections, the perceived area of screen 12 will appear with a strong visual distortion image 22, as shown in FIG. 2. Specifically, FIG. 2 depicts an actual rectilinear image (i.e., parallel vertical and horizontal lines) when perceived under such a distortion, referred to as either the barrel of fisheye effect. Note from FIG. 2 that points that depict a line, for all lines other than the middle axes, do not appear straight but rather bend to some extent. As a result, the preferred embodiments include additional aspects in detection apparatus 14_{D} so as to attempt to reduce these distortion effects, as further explored below.

FIG. 3 illustrates a diagrammatic view of detection apparatus 14_{D} in more detail. Detection apparatus 14_{D} includes a housing with a passage, window, or other near-IR transmitting area 30 through which reflected near-IR light beam RLB of FIG. 1c may pass. Transmitting area 30 may be implemented, therefore, as a filter that blocks all unwanted wavelengths, while allowing near-IR light to transmit to the interior of the detector 14_{D} housing. The filter can be a bandpass or long-pass filter, which reflects unwanted wavelengths and transmits the wavelength of light used for detection, in this case near-IR. Given transmitting area 30, and by ways of example in FIG. 3, therefore, separate reflected light beam RLB components RLB₁, RLB₂, and RLB₃ are shown passing through transmitting area 30 as individual rays. Detection apparatus 14_{D} also includes a curved (i.e., non-planar) mirror 32, which in one preferred embodiment is concave, but may be otherwise curved to be convex as well. Curved mirror 32 is preferably aspheric or free-form (extended polynomial), either of which may be constructed according to various principles known in that art. For example, once a desired curvature is determined, mirror 32 may be formed by molding plastic according to that curvature and forming a reflecting coating on the plastic. The desired curvature will depend on various factors as known in the art. In any event, the mirror surface is determined and oriented so that incident beams/rays entering through transmitting area 30 are reflected from the various curved locations of mirror 32 in a desired direction.

Light (e.g., RLB₁, RLB₂, and RLB₃) received by curved mirror 32 is reflected as a bundle of rays to a lens front group 34 and then continues to a lens rear group 36, both aligned along a common axis AX. In a preferred embodiment, lens front group 34 includes a concave Plano aspheric (plastic) lens 34ₖ, followed by two spherical (glass) lenses 34₂ and 34₃. Also in a preferred embodiment, lens rear group 36 includes a spherical (glass) lens 36₁ followed by a Plano aspheric (plastic) lens 36₂. Thus, FIG. 3 illustrates a preferred embodiment six optical element design for the reflection and transmission of light. Further, selection of alternative lenses for lens front group 34 and lens rear group 36 also may be achieved by one skilled in the art given various considerations, including wavelength selectivity, physical orientation, potential aberrations, and the like. For example, as known, aspherics permits in general a reduction in the number of lenses and elements needed. Other examples will be known and favorable to bend light appropriately and correct for aberrations.

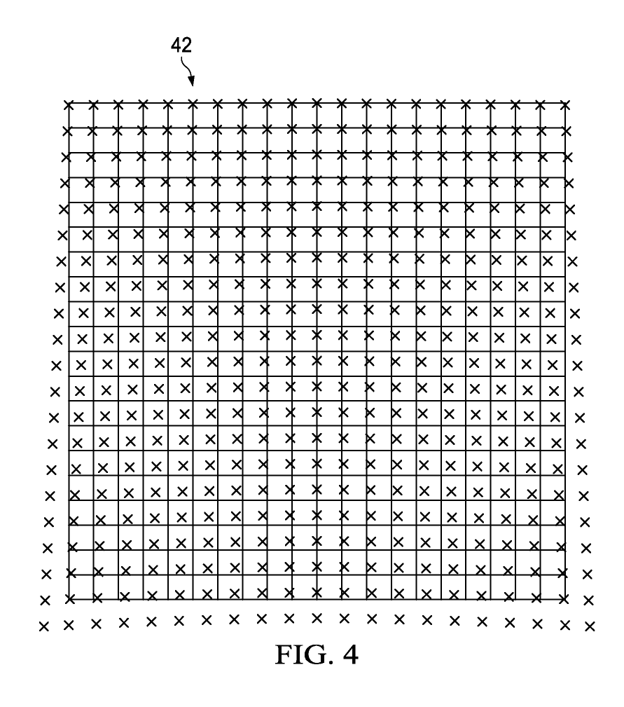

Detection apparatus 14_{D} further includes a camera 38, which is oriented so as to receive, via mirror 32, and groups 34 and 36, a full view of perimeter area 16 (see FIG. 1a). To achieve such orientation, camera 38 is offset from axis AX by at least a 105% offset, and more typically can be offset from 110 to 120%. Camera 38 thus receives light from lens rear group 36 and communicates data to, and is controlled by, processing circuitry 40. Processing circuitry 40 represents hardware and/or software algorithms as known in the art for light reflection processing and camera control, and also may be shared with the same circuitry that also provides the projection aspects described earlier in connection with FIGS. 1a and 1b. Such processing circuitry, therefore, may include a digital signal or other processor, memory, and related apparatus. With respect to camera 38, note that in various prior art interactive systems, fairly expensive cameras are required to support high resolution, typically considerably over 1 million pixels, as is complicated circuitry, both used to correct for the fisheye effect, particularly in wide angle orientations. In contrast, however, the preferred embodiment inventive use of curved mirror 32 has been found to adequately reduce distortion, so that camera 38 may be implemented using complementary metal-oxide-semiconductor (CMOS) technology at a Video Graphics Array (VGA) (i.e., 640×480 pixel) or WVGA resolution (e.g., 800×480). Indeed, FIG. 4 illustrates a distortion plot 42 as achieved by the preferred embodiment combination, including such a camera 38 and curved mirror 32. The plot illustrates (x, y) position detections with “X” characters, compared to true rectilinear lines that are also depicted. One skilled in the art can readily visually compare the slight bending of some lines formed by the X's as compared the rectilinear lines, although many X's are closely aligned with an underlining linear path. In this regard, the preferred embodiment has been measured to achieve a maximum distortion under ten percent, and of approximately 9.5 percent for an ultra-short throw projector configuration of 0.18.

From the above, various embodiments provide numerous improvements to the prior art. Such improvements include an ultra-short throw interactive projector configuration with a corresponding ultra-wide-angle detection apparatus, and thereby capable of ultra-short throw ratio (less than 0.38) configurations. Moreover, various aspects have been described, and still others will be ascertainable by one skilled in the art from the present teachings. For example, while certain lenses have been discussed, variations are anticipated including a change in the number of optical elements to something other than the six shown in FIG. 3. As another example, various orientations can be changed, particularly as the use of a curved mirror 32 permits the optical elements to be folded into a cube or other non-linear orientation, as opposed to requiring that the entire reflective light path be linear (e.g., in a lens barrel). As still another example, while detecting apparatus 14_{D} in one preferred embodiment is incorporated with the same housing or support structure as the projecting apparatus, in an alternative preferred embodiment camera 38 (and/or related detecting apparatus) may be mounted relative to screen 12, such as by way of a short mechanical boom (e.g., 15 inches or less in length), or in yet another preferred embodiment, it may be incorporated into screen 12 or its support structure. Moreover, multiple cameras may be implemented, each for accommodating a section of the screen (e.g., a half, a quadrant). Other advantages are also achieved. For example, the preferred embodiments permit an ultra-wide viewing angle while a thin, small form factor may be achieved. Thus, while various alternatives have been provided according to the disclosed embodiments, still others are contemplated. Given the preceding, therefore, one skilled in the art should further appreciate that while some embodiments have been described in detail, various substitutions, modifications or alterations can be made to the descriptions set forth above without departing from the inventive scope, as is defined by the following claims.

1. Interactive projection apparatus, comprising:
apparatus for projecting an image toward a screen; and
apparatus for capturing a reflection from an object touching a point adjacent the screen, comprising:
a curved mirror for receiving light representing the reflection;
at least one lens to which the curved mirror reflects light representing the reflection; and
a camera for receiving light representing the reflection from the at least one lens.

2. The interactive projection apparatus of claim 1 wherein the curved mirror comprises an aspheric concave mirror.

3. The interactive projection apparatus of claim 2 wherein the camera comprises a VGA camera.

4. The interactive projection apparatus of claim 2 wherein the camera comprises a WVGA camera.

5. The interactive projection apparatus of claim 4 wherein the camera comprises a CMOS camera.

6. The interactive projection apparatus of claim 1 wherein the curved mirror comprises a free-form curved mirror.

7. The interactive projection apparatus of claim 6 wherein the camera comprises a VGA camera.

8. The interactive projection apparatus of claim 6 wherein the camera comprises a WVGA camera.

9. The interactive projection apparatus of claim 8 wherein the camera comprises a CMOS camera.

10. The interactive projection apparatus of claim 1 wherein the camera comprises a VGA camera.

11. The interactive projection apparatus of claim 1 wherein the camera comprises a CMOS camera.

12. The interactive projection apparatus of claim 1 wherein the camera comprises a WVGA camera.

13. The interactive projection apparatus of claim 1 and further comprising processing circuitry coupled to the camera for processing data from the camera and determining a position on the screen corresponding to the object.

14. The interactive projection apparatus of claim 13 wherein the processing circuitry is operable to determine positions on the screen at a maximum distortion under ten percent.

15. The interactive projection apparatus of claim 1 and further comprising apparatus for emitting near-IR light adjacent the screen, wherein the reflecting is created by the object contacting the near-IR light.

16. The interactive projection apparatus of claim 12 wherein the apparatus for emitting near-IR light adjacent the screen comprises apparatus for emitting a light curtain adjacent an area of the screen.

17. The interactive projection apparatus of claim 1 wherein the apparatus for projecting and the apparatus for capturing are affixed relative to a same housing.

18. The interactive projection apparatus of claim 17 wherein the housing is positioned relative to the screen so as to have a throw ratio of 0.38 or lower.

19. The interactive projection apparatus of claim 17 wherein the housing is positioned relative to the screen so as to have a throw ratio of 0.18 or lower.

20. The interactive projection apparatus of claim 17 wherein the screen comprises a diagonal of 100 inches or greater.

21. The interactive projection apparatus of claim 1 wherein an alignment of the camera, curved mirror, and at least one lens is non-linear.

22. The interactive projection apparatus of claim 1 wherein the at least one lens consists of five lenses.

23. The interactive projection apparatus of claim 1 wherein the camera comprises a first camera, and further comprising at least one other camera to form a plurality of cameras, wherein each camera in the plurality of cameras is associated with a differing section of the screen.

24. The interactive projection apparatus of claim 1 wherein the apparatus for projecting comprises digital micromirrors.

25. The interactive projection apparatus of claim 1 wherein the apparatus for projecting comprises liquid crystal display technology.

26. The interactive projection apparatus of claim 1 wherein the curved mirror comprises a convex mirror.

27. Interactive detecting apparatus for use with a projection screen and for capturing a reflection from an object touching a point adjacent the screen, comprising:
a curved mirror for receiving light representing the reflection;
at least one lens to which the curved mirror reflects light representing the reflection; and
a camera for receiving light representing the reflection from the at least one lens.

28. A method of operating an interactive projection apparatus, comprising:
projecting an image toward a screen; and
capturing a reflection from an object touching a point adjacent the screen, comprising:
receiving light representing the reflection at a curved mirror;
reflecting the light representing the reflection to at least one lens; and
receiving, with a camera, light representing the reflection from the at least one lens.

29. The method of claim 28 wherein the curved mirror comprises an aspheric concave mirror.

30. The method of claim 28 wherein the camera comprises a VGA camera.

31. The method of claim 28 wherein the camera comprises a CMOS camera.
